(19) United States
(12) Patent Application Publication
(10) Pub. No.: US 2009/0223301 A1
(43) Pub. Date: Sep. 10, 2009

(54) Method and Apparatus for Testing Tubular Objects

(76) Inventor: Andreas Schwab, Riedenberg (DE)

Correspondence Address: GOODMAN, ALLEN & FILETTI PLLC, 4501 HIGHWOODS PARKWAY, SUITE 210, GLEN ALLEN, VA, 23060, US

(21) Appl. No.: 12/301,100

(22) PCT Filed: May 10, 2007
(86) PCT No.: PCT/DE2007/000864

§ 371 Date: May 20, 2009

(30) Foreign Application Priority Data
May 16, 2006 (DE) 10 2006 023 110.4

(51) Int. Cl. G01N 3/12

(52) U.S. Cl. 73/825

(57) ABSTRACT

A method for testing tubular objects, in particular paper sleeves in a cylindrical pressure chamber, comprises the following steps: receiving the tubular object to be tested in a pressure chamber, which is comprised of a hollow cylinder with a pressure shell, wherein the pressure shell is supported at the hollow cylinder and wherein an expansion of the pressure shell in radial outward direction and in axial direction is limited; loading the pressure shell with a pressure means, so that the inner surface of the pressure shell is evenly applied to the surface of the object; and providing a pressure increase until the terminal pressure to be tested is reached, or a damage of the tubular object occurs. The invention also relates to an apparatus for testing tubular objects, configured to use the method.

### CROSS REFERENCE TO RELATED APPLICATIONS

This application is a continuation of International Application No. PCT/DE07/000,864, filed May 10, 2007, claiming priority of German patent application DE102006023110A1, filed May 16, 2006, the disclosures of which are incorporated herein by reference.

### BACKGROUND OF THE INVENTION

The invention relates to a method for testing tubular objects, in particular paper sleeves, in a cylindrical pressure chamber and an apparatus to use the method.

So far testing methods are known, in which the tubular objects are directly loaded by a hydraulic fluid. Due to the high pressure, which has to be imparted, however, there are recurring problems regarding a reliable sealing, and furthermore, it cannot be ruled out that due to the direct contact with the hydraulic fluid a falsification of the test results occur.

From DE 603 00 993 T2, a method is known, in which the tubular component to be tested is received in a cylindrical pressure chamber, whose interior diameter is much larger than the component to be tested. The intermediary cavity is filled with small balls, which are pressurized from the outside in order to impart an even pressure onto the cambered surface of the tubular component to be tested. In order to prevent a direct contact of the pressure with the balls and with the component to be tested, a rubber membrane is provided onto which the pressure is imparted and by which the pressure is imparted onto the balls, which contact the surface of the tubular component. In order to achieve a sufficient tightness, it is thus required to fill the existing pressure cavity after inserting the tubular component, and to seal the cavity, so that the imparted pressure only impacts the balls provided therein. It has thus proven to be detrimental that the complexity of assembling and disassembling the test apparatus is very high, so that only few tubular components can be tested by the same testing apparatus in adequate time.

### BRIEF SUMMARY OF THE INVENTION

The invention relates to a method for testing tubular objects, in particular paper sleeves, in a cylindrical pressure chamber, which is comprised of the following steps:

receiving the tubular object to be tested in a pressure chamber, which is comprised of a hollow cylinder with a pressure shell, wherein the pressure shell is supported at the hollow cylinder and wherein an expansion of the pressure shell in radial outward direction and in axial direction is limited;

loading the pressure shell with a pressure, so that the inner surface of the pressure shell applies to the surface of the article evenly; and

performing a pressure increase until the final pressure to be tested is reached or a damage to the tubular object has occurred.

According to the invention, furthermore, a device for testing tubular objects is provided, which comprises a cylindrical pressure chamber for receiving the tubular object, a control unit and other pressure generating devices, wherein the pressure chamber is comprised of a hollow metal cylinder, in which a pressure shell is supported, which can be loaded by a pressure.

Various advantages of this invention will become apparent to those skilled in the art from the following detailed description of the preferred embodiment, when read in light of the accompanying drawings.

### BRIEF DESCRIPTION OF THE DRAWINGS

The invention is furthermore described in more detail based on the figures, wherein the illustrated embodiment does not restrict the scope of the invention, and wherein:

FIG. 1 illustrates the method according to the invention for testing the pressure resistance of a tubular object in a sectional side view;

FIG. 2 illustrates another side view of the device according to FIG. 1;

FIG. 3 illustrates the apparatus according to FIG. 1 with its outer shell in a first perspective view;

FIG. 4 illustrates the apparatus according to the invention according to FIG. 3 in a perspective sectional view;

FIG. 5 illustrates an embodiment for performing the test method; and

FIG. 6 illustrates a typical characteristic diagram of Eᵣ=Δp/ΔD of a paper sleeve.

### DETAILED DESCRIPTION OF THE INVENTION

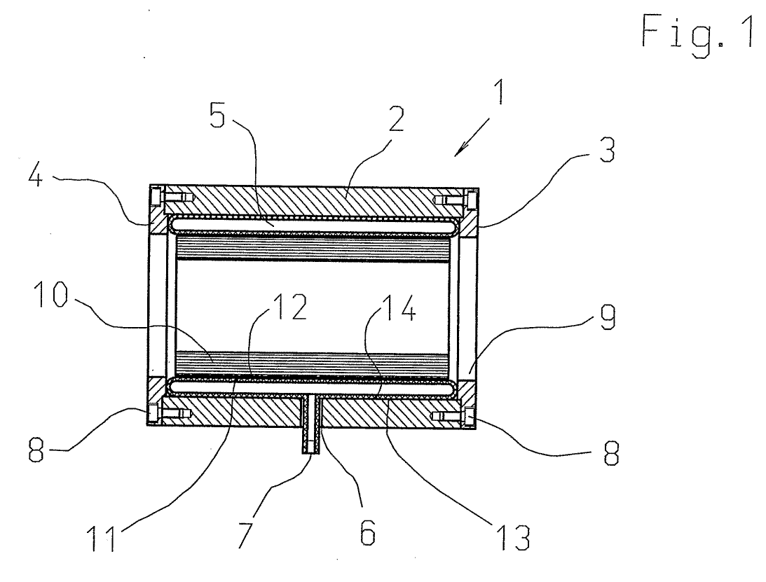

FIG. 1 shows an apparatus 1 according to the invention in a sectional side view, comprised of a hollow cylinder 2, two flange disks 3, 4 at the faces, and a pressure shell 5. The hollow cylinder 2 comprises an opening 6, through which a pressure connection 7 of the pressure shell 5 is run to the outside. At the face side, the hollow cylinder 2 is defined by two flange disks 3, 4, which are bolted to the hollow cylinder 2 by mounting bolts 8. The flange disks 3, 4 comprise an opening 9, through which the tubular object 10, which is to be tested, can be inserted.

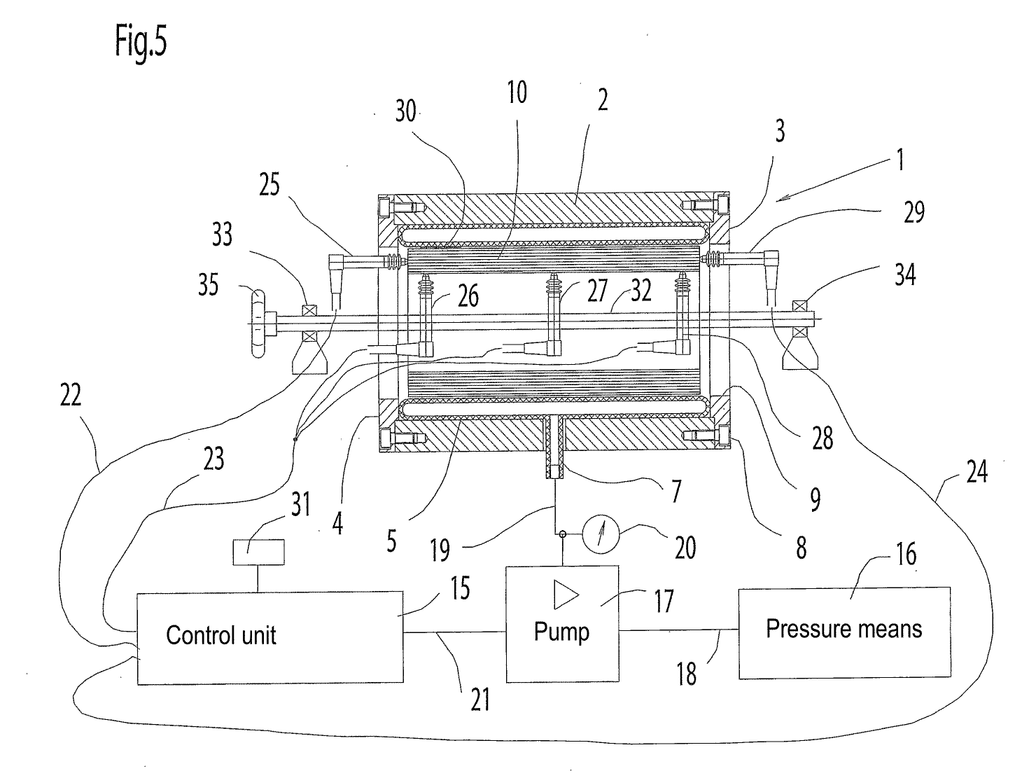

For the intended purpose, a paper sleeve section is used as an object 10, which is inserted into the apparatus 1 over its entire length and which is in direct contact with its inner surface with the inner surface 12 of the pressure shell 5. However, it is conceivable that the apparatus 1 is also used for testing other tubular objects, e.g. plastic sleeves. The pressure shell 5 contacts the inner surface 14 of the hollow cylinder 2 with its outer surface 13, so that in case of pressure loading, the pressure shell 5 can be supported at the hollow cylinder 2 and at the lateral flange disks 3, 4. Thus, an expansion of the pressure shell 5, which is provided as a pressure membrane or pressure cuff in the present embodiment, is only possible in radial direction towards the tubular object 10. The connection 7 of the pressure shell 5 is run through the bore hole 6 out of the hollow cylinder 2, so that a pressure, e.g. water, oil or a gel, can be supplied at high pressure. The pressure generating units and a control device are not shown in this configuration and can be derived from FIG. 5.

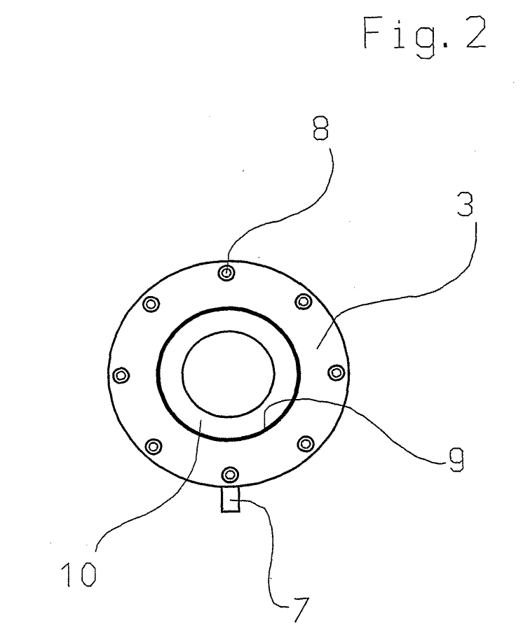

FIG. 2 shows the device 1 according to the invention in another side view, and thus in the direction of the face, so that only the flange disk 3 with the threaded bolts 8 and with the opening 9 and the inner tubular object 10 are visible.

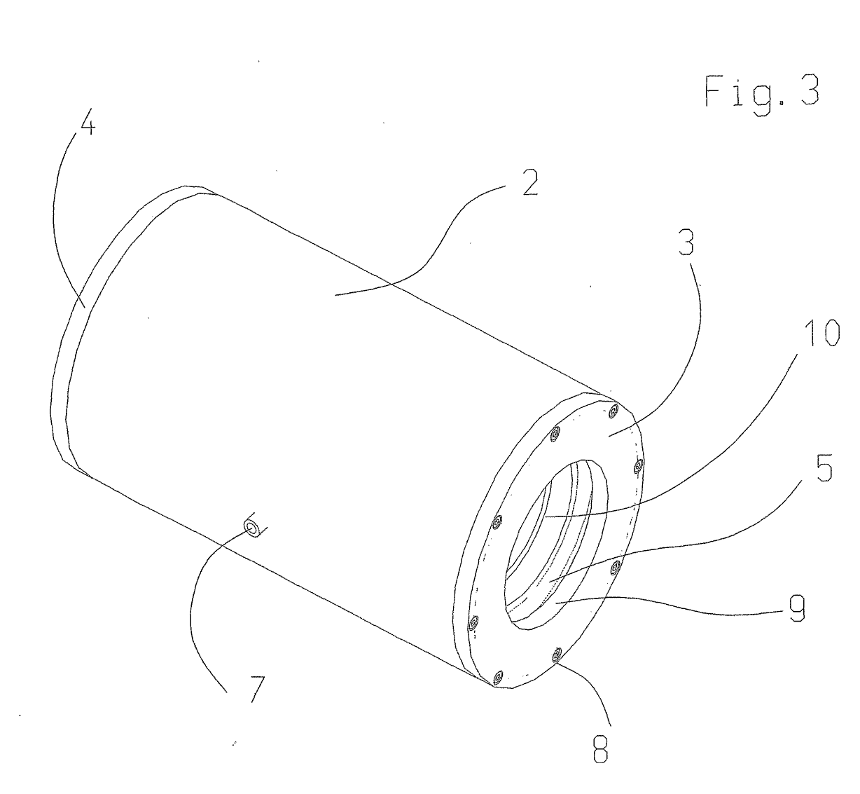

FIG. 3 shows the apparatus 1 according to the invention in a perspective view with a pressure connection 7 run out of the hollow cylinder 2, and flange disks 3, 4, which are bolted to the hollow cylinder 2 by the threaded bolts 8. The pressure shell 5 or the pressure cuff and the inserted tubular object 10 are visible through the cutout 9.

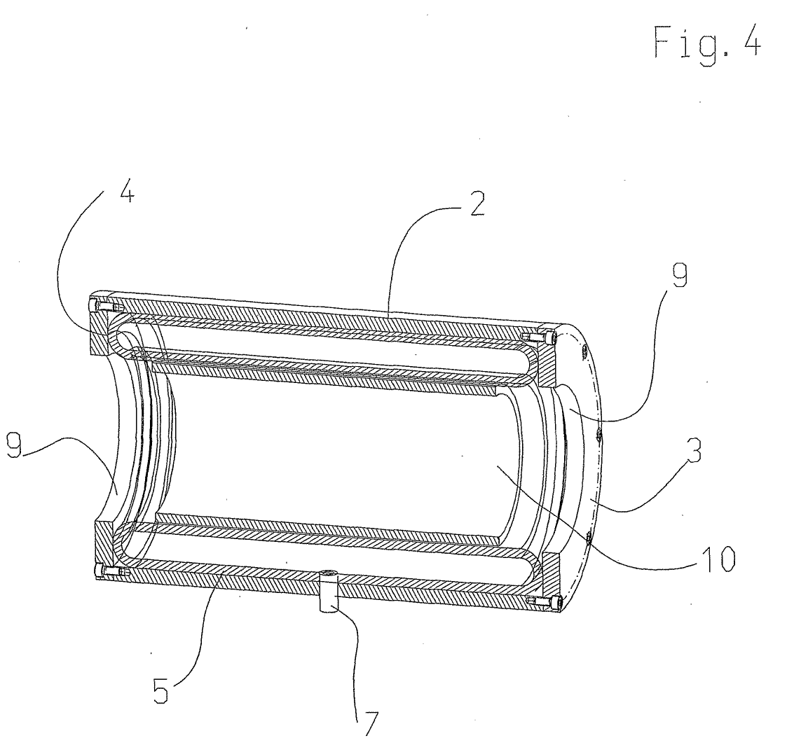

From FIG. 4, which illustrates the method according to the invention in a sectional view, it can furthermore be clearly derived, how the hollow cylinder 2 contacts the pressure shell 5 and how the pressure shell 5 contacts the tubular object. Also, the bolted connection of the flange disks 3, 4 with the hollow cylinder 2 is visible.

In order to test the tubular object 10, it is inserted through the opening 9 into the apparatus 1, and then the pressure can be supplied through the pressure connection 7. It only moves into the provided pressure shell 5, which is completely closed, and which, on the one hand, contacts the hollow cylinder 2, and on the other hand, contacts the tubular object 10. Due to the pressure rise, an even pressure is imparted from the outside onto the cambered surface of the tubular object 10, and an even pressure can be imparted, so that the tubular test object 10 can be tested with respect to its pressure resistance. Through additional sensors, which are not shown, thus a change of the inner diameter, of the entire length of the tubular object 10, and of the pressure generated can be measured, and through a control device, which is also not shown either, the sequence of the test program can be specified and the measured data can be recorded and documented.

FIG. 5 shows the method 1 according to the invention in a sectional view, comprised of the hollow cylinder 2 and two frontal flat disks 3, 4 and the employed pressure shell 5. An object 10, which is to be tested, is inserted into the device 1, and thus in the embodiment shown, this is a paper sleeve section, which is comprised of a plurality of wound paper layers. The entire test assembly is furthermore comprised of a control unit 15, which is used for processing the measurement value signals and for loading the pressure shell 5 with a pressure, wherein the pressure is supplied from the storage container 16 through a pump device 17 to the pressure shell 5. For this purpose, the pressure storage container 16 is connected by a feed line 18, on the one hand, to the pump device 17, and the pump device 17 is connected to the pressure connection 7 by an additional feed line 19. Additionally, a pressure measurement apparatus 20 is provided, which can directly display the pressure in the feed line 19. Through a feed line 21, the pump device 17 is controlled by the control unit 15. Furthermore, the control unit 15 is configured with feed lines 22, 23, 24, which lead to particular sensors 25, 26, 27, 28, 29. The sensors 25, 29 are used for determining a length change of the tubular object 10, while the sensors 26, 27, 28 monitor a possible deformation of the tubular object in radial direction. The tubular object 10 itself can furthermore be equipped with measuring foils 30 or measuring strips on its surface, which are partially wound about the tube shaped object, in order to thus determine the pressure distribution over the entire length of the tube. Through an acoustical and/or optical device 31, there is furthermore a possibility to indicate a sudden pressure drop due to the destruction of the tubular object 10.

Furthermore, the device 1 comprises a shaft 32, which is laterally supported by support elements 33, 34 and which comprises a hand wheel 35. At the shaft 32, the sensors 26, 27, 28 are mounted, which are disposed within the tubular wall 10, and which contact the wall of the tubular object with their measurement feelers. The sensors 26, 27, 28 are mounted to the shaft 32, so that by the sensors 26, 27, 28 and by operating the hand wheel 35, the circularity of the tubular object can be tested. The circularity test can e.g. be performed independent from the pressure loading in order to determine if the paper sleeves are configured with axial symmetry. By the sensors 26, 27 and 28 there is furthermore the possibility to determine, if the sleeve after pressure loading has the desired circularity without geometric distortions, in order to maintain a predetermined quality standard.

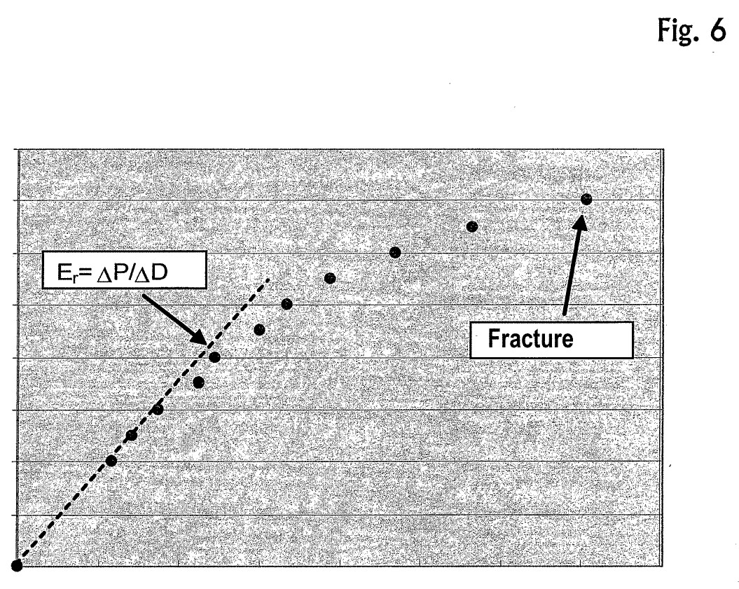

FIG. 6 shows the typical course of the characteristic diagram determined by the test device according to the invention. The ratio Eᵣ=Δp/ΔD initially shows a linear rise when the pressure is increased, before the characteristic diagram transitions into an asymptotic course until the point of fracture is reached.

The present invention can be used for all tubular objects in order to test their pressure resistance. Preferably, however, the method was developed to run paper sleeves through a standardized test with respect to their pressure resistance. According to the intended use, the tubular object, thus the paper sleeve, has sufficient pressure resistance, so that the materials wound onto the sleeve can be wound up without damaging the core and can be transported in particular after the windup has been performed. The tubular walls are thus widely used for a variety of applications, e.g. in the paper industry for winding up the raw paper for newspaper companies, wherein the paper sleeves can have a length of 10 meters or more and have to bear a load of up to 10 tons. The tubular objects are furthermore used for winding up foils, films, threads or yarns and textiles or synthetic fabrics, wherein in some cases the memory effect of the wound up plastic materials has to be considered, which can e.g. lead to a necking of the tubular objects, and thus leads to additional radial pressure loading. Accordingly, the paper sleeves are wound with thick walls, wherein various techniques, glues and manufacturing methods are used. Due to the intended loading of the paper sleeves, it is necessary that the manufacturers of such tubular products perform quality assurance and ensure certain pressure resistance properties to their customers. For this purpose, the cambered outer surface is loaded by a pressure and the pressure resistance is tested.

The method according to the invention is characterized in that the tubular object is received in a pressure chamber, which is comprised in principle of a hollow cylinder, preferably of a metal hollow cylinder with a pressure shell. Thus, the tubular object is inserted into the pressure chamber, so that the pressure shell partially contacts the arched surface of the tubular object without imparting pressure yet. After the pressure loading, the pressure shell evenly applies to the surface of the object over its entire circumference and is simultaneously supported at the hollow cylinder, so that the additional pressure buildup is only transferred to the surface of the tubular object. Thus, a controlled pressure increase is performed until the end pressure to be tested is achieved, and thus the stability of the tubular object is assured, or damage has occurred. If an early damage of the tubular object occurs, the required pressure resistance is not provided, however, when the maximum end pressure is reached and recorded accordingly, the tubular object has passed the portion of the quality test, so that the present test result can be used as a quality certificate for customers.

An exchange of the tubular object is possible in a short time, since e.g. only a pressure relief is required in order for the tubular object to be able to move freely again within the pressure shell. After supplying another tubular object, another test can immediately be performed without requiring complex sealing measures.

The method according to the invention is thus characterized in particular in that a tubular object to be tested, e.g. a paper sleeve, is inserted into the test apparatus and a pressure loading is performed by the pressure shell onto the surface of the tubular object over the entire length of the test apparatus, wherein the expansion of the pressure shell in radial outward direction and in axial direction is limited. With this pressure loading, thus, a removal can only be performed in the direction of the extension of the tubular object. After the completion of the test, this means either reaching a predetermined end pressure or after a damage of the tubular object has occurred, only a short pressure relief has to be performed in order to exchange the tubular object. Complex sealing measures are not required either, when high test pressures need to be imparted, since only the interior volume of the loaded pressure shell comes in direct contact with the applied fluid.

No clamping at the end of the test device is required and the length of the surface to be tested can be configured much larger. Thus, only the length of the test device is relevant, and it can be sized accordingly. By this type of clamping, it is assured in particular that the tubular object, e.g. a paper sleeve, performs like in the subsequent application, and goes through distortions or compressions due to the pressure loading, which extend over the entire axial length of the sleeve, so that possible weak spots lead to a destruction of the sleeve. Thus, such a test is much more realistic, and furthermore due to the simplicity of the test assembly it can be performed quickly and in a flexible manner.

The test apparatus can be built very long, using the configuration according to the invention, and thus absolutely realistic load tests can be performed upon the paper sleeves. Furthermore, the testing device facilitates detecting length- and diameter changes during the pressure increase, so that the typical behavior of the paper sleeve to be tested can be determined before destruction occurs. Typically, when the pressure increases, initially a linear rise of the ratio Eᵣ=Δp/ΔD occurs before the point of fracture is reached after an asymptotic course of the characteristic diagram. Thus, this is the typical behavior of a wound tubular sleeve during practical application, if the sleeve was sized too weak.

Even pressure is imparted onto the cambered surface of the tubular object by the pressure shell, and for this reason, a shape is selected, which encloses the tubular object in a coaxial manner. As a hydraulic pressure, preferably a liquid, e.g. water, an oil or a gel, is suitable. Alternatively, there is the possibility to use a mix of the pressure.

In order to assure an even pressure loading of the tubular object, it is furthermore provided that the extension of the pressure shell is limited, on the one hand, by the hollow cylinder and, on the other hand, by flange disks at the ends, so that under pressure loading, an extension can only occur in the direction of the tubular object.

For record keeping, it is thus provided that the monitoring and display of the respective pressure is performed by manometers until the required end pressure is reached. In case of a premature destruction of the tubular object, the damage can be indicated by detecting a sudden pressure drop due to a compression of the tubular object.

In another embodiment, there is the possibility to monitor the inner diameter during pressure loading, in order to also record the stability of the shape during the pressure loading, and thus the change of the shape. Thus, furthermore, there is the possibility to monitor a longitudinal change of the tubular object, in order to also record the change of shape. Furthermore, by an additional rotating device, the concentricity of the tubular object can be tested. This measure is of particular importance for fast rotating tubular objects, since a small imbalance can already cause big problems.

A surface test of the tubular objects can be performed simultaneously. In many cases the paper sleeves are provided with a finish layer, which shall prevent damages to the materials to be wound up. The finish layer can thus comprise a different layer thickness and it is adapted to the respective application. When e.g. foils are to be wound onto paper sleeves, they must not be damaged, and for this reason a soft finish layer is wound on. With the present test method, there is the option to measure the change of the surface during the pressure buildup until the end pressure is reached after removal of the tubular object from the test device. If the surface has gone back to its original shape in a flat and elastic manner, damage of the materials to be wound up can be ruled out. However, when the surface has uneven spots due to the pressure loading, or when the surface tends to form cracks, there is the risk that materials wound onto the sleeve are also damaged. Through the method according to the invention, thus, there is the option during the test to simulate certain pressures and to test the respective surface condition and to increase this up to maximum pressure, so that already early on a deformation of the surface can be detected in certain test steps.

According to the invention, furthermore, a device for testing tubular objects is provided, which comprises a cylindrical pressure chamber for receiving the tubular object, a control unit and other pressure generating devices, wherein the pressure chamber is comprised of a hollow metal cylinder, in which a pressure shell is supported, which can be loaded by a pressure.

For reasons of stability, the hollow cylinder employed is made of metal and comprises a respective wall thickness. The pressure shell is supported within the metal hollow cylinder, which is either directly connected to the inner surface of the metal hollow cylinder, or which is inserted in the shape of a loosely inserted flexible cuff. In case of a loading with a pressure, thus, the cuff or the pressure shell expands and it is supported with its outer surface at the metal hollow cylinder, while the inner surface is evenly applied to the tubular object. In order to achieve an even contact pressure on the tubular object, in particular on the paper sleeve, the expansion of the cuff is limited in radial direction by the hollow cylinder and limited by flange disks in axial direction, wherein the flange disks are bolted to the hollow cylinder at its face, and comprise an opening, which is adapted to the exterior diameter of the tubular objects, so that the largest objects to be tested can be inserted into the hollow cylinder through the flange disks. Thus, the accessibility of the test apparatus on both sides is particularly advantageous. The pressure shell itself is loaded by a pressure, which can be supplied from the outside by a pressure connection, wherein any position can be selected for the pressure supply. Preferably, the pressure connection is thus run through the hollow cylinder radially to the outside, so that the linking of the pressure connection to the pressure shell or to the cuff is supported form locked relative to the hollow cylinder, so that a mechanical loading can be excluded. The sleeve employed is thus disposed between the hollow cylinder and the tubular object, and it is pressed against the surface of the hollow cylinder and against the surface of the tubular object when loaded with pressure. Hereby, it is assured in particular that a development of wrinkles or an uneven contact at the object to be tested is avoided. The durability of the cuff is thus configured for a plurality of tests, while the apparatus is furthermore characterized in that the objects to be tested can be easily inserted into the test apparatus from both sides, and can thus be removed again with the same ease. The cuff can e.g. be comprised of a flexible rubber cuff or of a mix of textile fibers, synthetic fibers or rubber type materials.

During the testing process, it is provided in another configuration of the invention that the pressure buildup is continuously monitored and recorded by manometers, wherein a sudden pressure drop is immediately detected and indicates damages to the tubular object. Every time the paper sleeve cannot bear the pressure loading anymore, a deformation occurs, so that not only the surface, but also the wall thickness and the present geometry are impaired. When a yielding occurs, thus, the rubber sleeve can expand immediately, which creates a brief but clearly detectable pressure drop. Furthermore, there is the possibility to monitor and to record the inner diameter and also the longitudinal change of the tubular objects by sensors, so that the occurring shape changes, which are also undesirable, do not exceed a typical tolerance dimension. All recorded measurement values can thus provide quality assurance for a certain product when combined in a protocol, wherein the product complies with pertinent requirements after the test has been passed.

Preferably, an electronic control unit, in particular a computer based control unit, can be used for the test device, which does not only monitor the sensors and receives and stores their measurement values, but also controls the loading with pressure accordingly, wherein upon requirement, the transmission of the stored data to a data storage device or to a superimposed communication unit is performed. Furthermore, there is the possibility that in case of a quick pressure drop through a damage of the tubular object, an optical and/or acoustic signal generator is activated, so that independent from the electronic control unit, it is immediately evident to the test operator that the test process can be aborted, because the tubular object has not sustained the loads. In order to generate a sufficient end pressure, pressure generating devices are provided, which comprise at least a pressure container, a pump and a feed line to the pressure shell, so that the pressure can be continuously monitored and supplied. Additionally, further sensors in the form of foils or measurement strips can be provided on the surface of the tubular objects in order to monitor the surface loading.

It is provided in a particular configuration that the test apparatus comprises a shaft, which is supported by support elements, and comprises a hand wheel, wherein the sensors are rotationally connected to a shaft. By the shaft, the concentricity can be tested before or after the pressure test has been performed, which has to be considered in particular for fast running print presses.

Thus, it can be stated in summary, that through the method according to the invention and through the apparatus provided for performing the method, a plurality of tubular objects can be tested within a short period of time with respect to their pressure resistance, wherein the particularity of the method is that a quick exchange of the tubular object is assured and complex sealing measures, threaded connections, etc., which are required after each insertion of a tubular object, can be avoided. By the apparatus, furthermore a continuous test process can be performed comprising a quick exchange of the tubular objects and an immediate reuse of the test apparatus.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A method for testing tubular objects, characterized by the following steps:
(a) receiving the tubular object to be tested in a pressure chamber, which is comprised of a hollow cylinder with a pressure shell supported at the hollow cylinder, wherein an expansion of the pressure shell in radial outward direction and in axial direction is limited;
(b) loading the pressure shell with a pressure, so that an inner surface of the pressure shell is evenly applied to a surface of the object; and
(c) providing a pressure increase until a terminal pressure to be tested is reached, or a damage of the tubular object occurs.

2. A method according to claim 1, wherein an even pressure is applied to a cambered surface of the tubular object by the pressure shell.

3. A method according to claim 1, wherein a liquid, a gel or a mix thereof is used as a hydraulic pressure.

4. A method according to claim 1, wherein the expansion of the pressure shell is limited by the hollow cylinder and by flange disks at its ends, so that an expansion in a direction towards the tubular object is achieved.

5. A method according to claim 1, wherein the pressure within the pressure shell is monitored by a manometer.

6. A method according to claim 1, wherein detection of a sudden pressure drop indicates damage of the tubular object.

7. A method according to claim 1, wherein an inner diameter is monitored by additional sensors.

8. A method according to claim 1, wherein a change in length of the tubular object is monitored by sensors.

9. A method according to claim 1, wherein a surface test of the tubular object and a test of geometric distortion is performed by a test apparatus.

10. An apparatus for testing tubular objects, comprising a cylindrical pressure chamber for receiving the tubular object, a control unit and an additional pressure generating device, wherein the pressure chamber is defined by a hollow cylinder, which is made of metal, and in which a pressure shell is supported, which can be loaded by a pressure, wherein an inner surface of the pressure shell is applied to the tubular object when pressure is applied, while an outer surface is supported at the hollow cylinder, wherein an expansion of the pressure shell in radial outward direction, as well as an axial expansion of the pressure shell are limited.

11. An apparatus for testing tubular objects according to claim 10, wherein the pressure shell is comprised of a flexible cuff.

12. An apparatus for testing tubular objects according to claim 10, wherein the pressure shell can be loaded by a pressure, which can be inducted from an outside by a pressure connector.

13. An apparatus for testing tubular objects according to claim 10, wherein the pressure connector is run through the hollow cylinder in outward radial direction.

14. An apparatus for testing tubular objects according to claim 10, wherein the hollow cylinder is secured to flange disks at its face, which comprise an opening, which is adapted to an outer diameter of the tubular objects.

15. An apparatus for testing tubular objects according to claim 10, wherein an pressure increase can be controlled by a manometer.

16. An apparatus for testing tubular objects according to claim 10, wherein a pressure drop can be detected by a sensor in order to determine thermal damage to the tubular object.

17. An apparatus for testing tubular objects according to claim 10, wherein an inner diameter of the tubular object and/or a change in length can be detected by sensors.

18. An apparatus for testing tubular objects according to claim 17, wherein the sensors are monitored, and measurement values are stored, and pressure loading is controlled, wherein the stored information is relayed when required.

19. An apparatus for testing tubular objects according to claim 10, wherein in case of a pressure drop, at least one of an optical signal generator and acoustic signal generator can be activated.

20. An apparatus for testing tubular objects according to claim 10, wherein the pressure is generated by a generating device comprising at least one pressure container, a pump, and a feed line towards the pressure shell.

21. (canceled)

22. (canceled)
